(19) United States
(12) Patent Application Publication
(10) Pub. No.: US 2012/0005159 A1
(43) Pub. Date: Jan. 5, 2012

(54) SYSTEM AND METHOD FOR CLOUD FILE MANAGEMENT

(76) Inventors: Weihan WANG, Palo Alto, CA (US); Yuri SAGALOV, Palo Alto, CA (US)

(21) Appl. No.: 13/176,528

(22) Filed: Jul. 5, 2011

Related U.S. Application Data
(60) Provisional application No. 61/361,221, filed on Jul. 2, 2010.
(60) Provisional application No. 61/361,223, filed on Jul. 2, 2010.

(51) Int. Cl. G06F 17/30

(52) U.S. Cl. 707/617; 707/E17.005

(57) ABSTRACT

A system and method for cloud file management are disclosed. According to one embodiment, a computer-implemented method comprises registering the first user and the first device with a server, creating a library for object storage, transmitting an invitation to access the library to a second user, the second user having a second device, verifying and granting the second user access to the library, wherein granting the second user access to the library comprises granting the second device access to the library. An object having a replication factor and two or more components is stored on one or more of the first device and the second device according to the replication factor and total storage available on the first device and the second device.

This application claims the benefit of priority to U.S. Provisional Application Ser. No. 61/361,221, titled “System and Processes for Cloud File Storage,” filed Jul. 2, 2010, and U.S. Provisional Application Ser. No. 61/361,223, titled “A System and Method for Secure File Management in a Cloud,” filed Jul. 2, 2010, both of which are fully incorporated herein by reference.

### FIELD

The present system and method relate generally to computer systems, and more particularly, to cloud file management.

### BACKGROUND

File sharing is the practice of distributing or providing access to digitally stored information, such as computer programs, multimedia (audio, images, and video), documents, or electronic books. It may be implemented through a variety of ways. Storage, transmission, and distribution models are common methods of file sharing that incorporate manual sharing using removable media, centralized computer file server installations on computer networks, World Wide Web-based hyperlinked documents, and the use of distributed peer-to-peer networking.

### SUMMARY

A system and method for cloud file management are disclosed. According to one embodiment, a computer-implemented method comprises registering the first user and the first device with a server, creating a library for object storage, transmitting an invitation to access the library to a second user, the second user having a second device, verifying and granting the second user access to the library, wherein granting the second user access to the library comprises granting the second device access to the library. An object having a replication factor and two or more components is stored on one or more of the first device and the second device according to the replication factor and total storage available on the first device and the second device.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates an exemplary computer architecture for use with the present system, according to one embodiment.

FIG. 2 illustrates an exemplary architecture of the present system, according to one embodiment.

FIG. 3 illustrates a device architecture for use with the present system, according to one embodiment.

FIG. 4 illustrates an exemplary version table for use with the present system, according to one embodiment.

FIG. 5A illustrates an exemplary initial installation process for use with the present system, according to one embodiment.

FIG. 5B illustrates an exemplary subsequent installation process for use with the present system, according to one embodiment.

FIG. 6 illustrates an exemplary access control list for user with the present system, according to one embodiment.

FIG. 7 illustrates an exemplary library management process for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

A system and method for cloud file management are disclosed. According to one embodiment, a computer-implemented method comprises registering the first user and the first device with a server, creating a library for object storage, transmitting an invitation to access the library to a second user, the second user having a second device, verifying and granting the second user access to the library, wherein granting the second user access to the library comprises granting the second device access to the library. An object having a replication factor and two or more components is stored on one or more of the first device and the second device according to the replication factor and total storage available on the first device and the second device.

According to one embodiment, the present system provides libraries as part of a virtualized, peer-to-peer, replication file system. The storage space of a library is contributed to by one or more consumer (also referred to herein as “user”) devices such as laptops, desktops, smart phones, owned by end users, as well as server devices owned by the consumer or a third party. Data is replicated among these devices. Unlike traditional systems where all the computers in a cluster sit in a single LAN environment, the present devices can be distributed across wide area networks. Users can continuously read and write data, even if the user's current device is disconnected from all other devices. In addition, the present system is a multi-master system, where any device may write data rather than a single-master system where all write operations must be submitted to a single master device.

According to one embodiment, each user of the present system is assigned an identity that is used to define device ownership and access control. A person is a user if and only if the person has an identity registered with the registration server.

According to one embodiment, each device is owned by a user. A user may own zero or more devices. Ownership of a device is determined when the device is created or registered with the present system, and generally does not change during the device's life cycle. Only the user who owns a device may login and use the device. One physical or virtual computer may host more than one device. The devices hosted by the physical or virtual computer may be owned by different users, as the physical or virtual computer can be running multiple instances of the present system at the same time.

According to one embodiment, a device may contribute to zero or more libraries. When a device contributes to a library, the device dedicates storage space to store the library's data as well as metadata, and communicates with other contributing devices for data synchronization and other tasks. Devices not contributing to a library may also access the library, as long as the owner of the device is granted access to the library. Such devices are analogue to Web browsers: They may browse and cache contents of the library but do not participate in the library's data exchange with other devices.

According to one embodiment, the present system exposes a file system interface to end users. On Microsoft Windows for example, users are presented with their present device as a drive with an associated drive letter within the user interface. Files and folders in the file system are objects. An object has data and metadata. Metadata contains information about an object such as file attributes, creation date, and version numbers.

### Computer Architecture

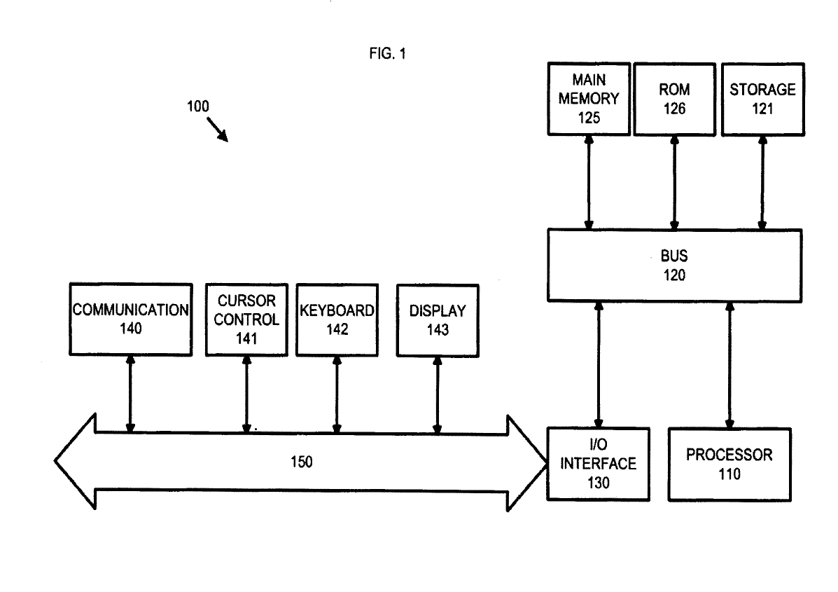

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

### System Architecture

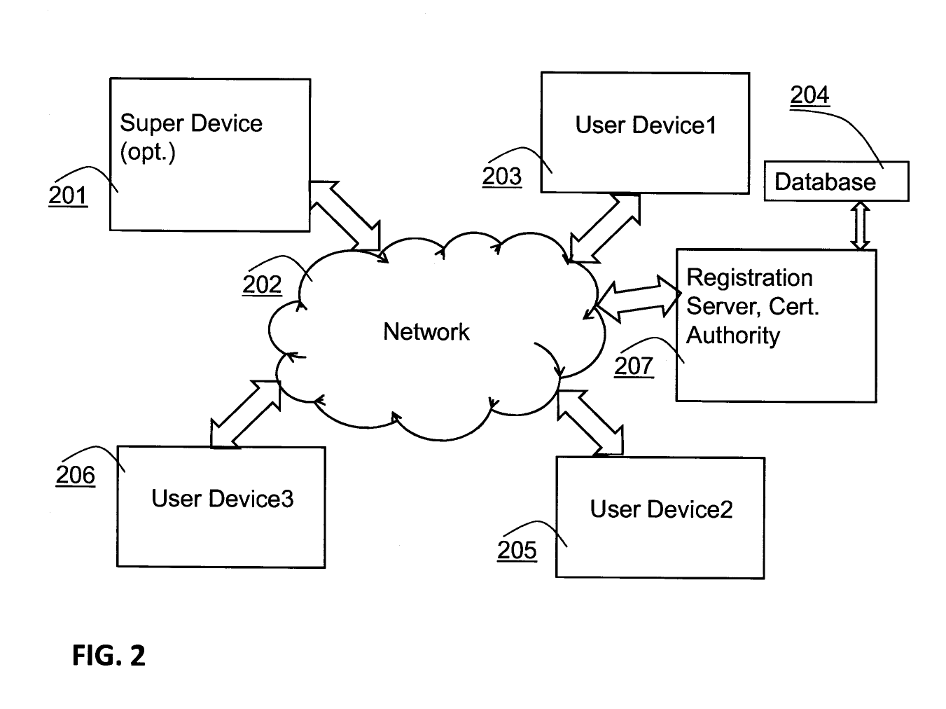

FIG. 2 illustrates an exemplary architecture of the present system, according to one embodiment. Multiple devices 201, 203, 205, 206 communicate over a network 202. The network 202 (also referred to herein as an overlay network) enables direct communication between any two peers/devices even if the peers/devices have dynamic IP addresses, are behind firewalls, or if the peers cannot directly send IP packets to each other for any other reason.

Devices 201, 203, 205, 206 can be a user's own devices or servers provided by third-party service providers. Servers can be from different providers to ensure high availability or other reasons. Devices 201, 203, 205, 206 can be automatically or manually appointed as super devices (e.g. 201). Super devices (201) are identical to other devices except that they are more active and aggressive in data synchronization, and perform more tasks such as helping other devices establish network 202 connections and propagate updates.

A registration server 207 (optionally in communication with a database 204) ensures global uniqueness of various types of identifiers. It is used in conjunction with a certificate authority (CA) to register identifiers and to issue certificates binding the identifiers with appropriate public keys. Communication between devices 201, 203, 205, 206 is purely peer-to-peer, without involving either of the two servers (registration and CA) 207. Devices 201, 203, 205, 206 refer to the servers 207 only when registering or looking up new identifiers, or updating Certificate Revocation Lists (CRL).

Libraries are identified by library addresses, which are globally unique strings of arbitrary lengths. Users are identified by user IDs which are also globally unique strings of arbitrary lengths. According to one embodiment, User IDs are email addresses. A device ID is the device owner's user ID combined with a 32-bit integer value. The integer value is unique in the scope of the user ID. The device ID never changes during a device's life cycle. Objects are identified by object IDs. According to one embodiment, an object ID is a type 4 (pseudo randomly generated) UUID and paths are part of an object's metadata.

The central registration server 207 guarantees the uniqueness of the identifiers (IDs). Devices 201, 203, 205, 206 generate IDs and register them with the registration server 207. A device (e.g. 201, 203, 205, 206) must re-generate a new ID if the server 207 finds the ID is already registered and returns an error to the device.

According to one embodiment, a public/private key pair is associated with each user. Key pairs are generated with an algorithm (one such example is RSA/ECB/PKCS1Padding, other algorithms may be used). According to one embodiment, public keys are encoded in X.509 format, and private keys are PKCS#3 encoded. According to one embodiment, the Java virtual machine default security provider is used for key generation and other security-related tasks.

Public keys are certified by the Certificate Authority (CA) 207. Users may choose to use any CA they trust. Certificate verification is part of the authentication process. Devices periodically update root certificates and Certificates Revocation Lists. Such information may be saved in libraries and is automatically synchronized with other contributing devices.

According to one embodiment, several hard drives or other media on a device can be used at the same time. For example, if a user adds two drives to be used with 100 GB each, 200 GB of data can be stored on the device. In addition, the user may designate a quota for each drive by specifying either an absolute capacity or the percentage relative to the capacity of the drive or relative to the free space on the drive.

### Device Architecture

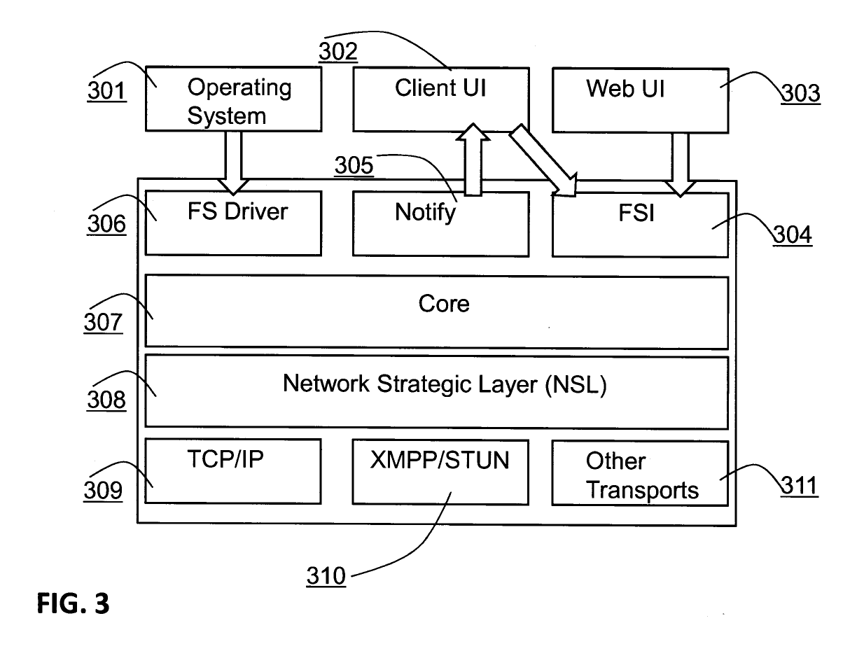

FIG. 3 illustrates a device architecture for use with the present system, according to one embodiment. A daemon (including 304-311 of FIG. 3) performs all core logic including data management, communicating with other devices, and serving file system requests. An interface (including 301-303 in FIG. 3) exposes functions to the user through appropriate user interfaces. The daemon and interface run in different processes, communicating through Remote Procedure Calls (RPC, shown as arrows in FIG. 3).

A operating system 301 forwards file system requests (e.g. file read/write) from a requesting application to the daemon (at 306), and passes results back to the requesting application. A client UI 302 exposes functions such as user and device management. These functions are beyond typical file system operations. A web UI 303 allows the user to access library data remotely through a Web browser. The web UI 303 is typically present on could servers that provide a Web interface for data access.

A file system (FS) driver 306 exposes a locally mounted file system. On Microsoft Windows for example, the driver presents a drive with a drive letter (e.g. Z:\). A FSI (file system interface) 304 exposes API calls to the client UI 302 and web UI 303. These API calls are a super set of typical file system operations. A notify interface 305 is the interface through which the daemon notifies various events such as file changes to the processes that have subscribed for the events. This notification mechanism is mainly used to refresh user interfaces.

The core 307 performs core logic including data management and synchronization. The core 307 runs on top of an overlay network, and is agnostic on the actual network technologies on which the overlay network operates (e.g. TCP, XMPP, etc). The modules under the core 307, i.e. the network strategic layer (NSL) 308 and transport modules 309, 310, 311, implement the overlay network. They together enable the local device to communicate directly with any other devices over any networks of arbitrary topologies.

Transport modules include TCP/IP 309, XMPP/STUN 310, and other transports 311. Each transport (309, 310, 311) supports a single network transport technology. Multiple transports work together to provide maximum connectivity as well as best performance.

Consider the following example: When two devices are within the same Local Area Network (LAN), they may be directly connected using TCP or UDP. The TCP/IP transport will detect this situation and connect the two devices. However, if the two devices are behind their own firewalls, TCP/IP transport will fail. Meanwhile, the XMPP/STUN module is able to connect the peers using an intermediate XMPP server and the STUN protocol.

The network strategic layer (NSL) 308 ranks transports when more than one transport is available to connect to a remote device. The NSL 308 selects the best transport based on various transport characteristics and network metrics. In the previous example, if the two peers are within the same LAN, both TCP/IP 309 and

XMPP/STUN 310 modules are able to connect them. When sending messages between the peers, NSL 308 is likely to select TCP/IP 309 as the preferred transport as it typically has lower latency and higher throughput.

The overlay networking layer implemented by the network strategic layer (NSL) 308 and transport modules 309-311 is exposed to the core 307 via a programming interface. The core 307 uses this interface to communicate with other peers on the overlay network without knowing actual transport implementations. The interface defines common network protocol primitives must be supported by the transports. Examples of network protocol primitives include the following:

Atomic message: Atomic messages are like datagram packets. They may be delivered out of order and may be dropped silently. There is no flow control for atomic messages. Each transport suggests to the core a maximum atomic message size they can handle, and is free to drop messages that are too large. Partial delivery is not accepted. The entire message is either fully delivered or fully dropped. There are three types of atomic messages: unicast, maxcast, and wildcast.

Unicast atomic message: The destination of a unicast atomic message is always a particular device identified by the device id.

Maxcast atomic message: a maxcast atomic message is destined to all the devices contributed to a specified library. It is similar to conventional multicast which sends packets to a group of devices. However, maxcast significantly differs in that it allows the implementing transport deliver the message to an arbitrary number (including zero) of destination devices, although it is encouraged to deliver to as many devices as possible with best efforts. Maxcast is useful to many network applications that require wide-area multicast. Reliable multicast across the Internet, however, is too expensive to be practical. Maxcast suggests an alternative approach for network applications where the application is aware of and capable to handle unreliability in an application specific way.

Wildcast atomic message: a wild atomic message is destined to all the devices the local device can reach. Similar to maxcast, wildcast does not require reliable delivery.

Stream: a stream is a data flow destined to a specified remote device. Unlike atomic messages, streams require in-order and flow-controlled delivery of data in a stream. Any delivery failure shall be reported to the core. There may be multiple concurrent, interweaving streams from one device to another. Data from different streams may be delivered out of order.

### Synchronization and Consistency

Devices contributing to a library continually perform pair-wise information exchange to synchronize objects in that library. Because any device may be disconnected at any time, the optimistic replication is enabled. That is, an object is not guaranteed to be synchronized across all the devices at all times. Instead, a device is allowed to update an object even if it is disconnected. Updates are opportunistically propagated to other devices. As a result, two or more devices can update an object at the same time. Such update conflicts are allowed and are resolved either automatically or manually when detected at a later time.

According to one embodiment, eventual consistency is provided by the present system. That is, no assumption is made as to how long it takes for an update to reach from one device to another or when two devices get synchronized (i.e. each device has all the updates known by the other). Multiple techniques are provided for herein to expedite update propagation with best effort, and that allow end users to forcibly synchronize one device from the other. After the update process, the former device is guaranteed to have all the updates known by the latter.

Not all contributing devices are required to store all data contained within a library. Redundant data is removed and the degree of replication is reduced if device space is full. This is useful when the device space is constrained, or the user wants to integrate the capacity of several devices into a bigger storage pool.

Consider the following example: suppose a library is contributed to by two devices with 100 GB storage each. If the total amount of data in the library is 100 GB or less, every byte will be replicated on both devices. However, if there is 120 GB worth of data, only 80 GB will be replicated. The remaining 40 GB has only one copy residing on either device. When there is 200 GB worth of data, no data can be replicated. However, the capacity is maximized in this case.

According to one embodiment, which set of data is to be replicated or evicted is chosen based on heuristics of usage patterns. For example, data that has not been access for a long time can be evicted. The replicated and evicted datasets on each device are adjusted dynamically based on runtime measurements. An algorithm is used to guarantee any piece of data has at least N copies throughout the system where N is a user specified number with the minimum value of 1. This number is 1 in the above example.

According to one embodiment, a user can pin objects to a particular device. Pinned objects are never evicted from the device even if the device is full. The maximum capacity of a library is reduced as a result.

In any case, the user sees the same dataset containing all the objects on any devices, even though some objects do not physically reside on the device. When the user requests to open one of these objects, the system will attempt to download the object from other devices while opening the objects—this scenario is streaming. Streaming may fail if there is not available device to stream the data from.

### Update Propagation: Components and Component Handler Plug-Ins

Updates are defined in a sub-object unit referred to as components. Each file has two or more components. Component one is defined as metadata component, referring to all the fields of the file's metadata; component two is defined as content component, referring to the entire content of the file. Application developers can arbitrarily define component three and above. Each folder has one or more components. Component one are metadata components. Component two and beyond are determined by application developers. When updating an object, a component number is associated with the update. If the application does not provide a component number, default numbers are used. For example, because applications cannot associate component numbers for updates through the local file system interface, these updates are assigned default numbers.

The combination of an object id and a component number is a component id. A component id uniquely identifies a component.

Using components rather than objects as update units allows updates to be propagated in a finer granularity than sending the entire objects. This is helpful for applications that manage large files such as databases and media editing tools. For example, suppose a calendar application uses a single file to store all calendar entries. The developer may assign each calendar entry with a component number, and pass the number to the present device whenever updating an entry. Therefore, when an entry is updated, only the data of the entry, rather than the entire file content, needs to be transmitted over the network. However, applications register component handler plug-ins that map a given component number to its corresponding data in an application specific way.

### Update Propagation: Epidemic Update Propagation

According to one embodiment, epidemic algorithms propagate updates. In particular, each device periodically polls for updates from a random online device which contributes to the same library. In order to speed up propagation for new updates, whenever an update is made on a device, the device pushes the update to other devices using maxcast atomic messages. The message contains the version of the update and optionally the update itself if the size of the update is insignificant. In the actual implementation, several updates are aggregate into one message. A more detailed description of epidemic algorithms is provided in Demers, A., et al. “Epidemic algorithms for replicated database maintenance.” Proceedings of the Sixth Annual ACM Symposium on Principles of Distributed Computing (Vancouver, British Columbia, Canada, Aug. 10-12, 1987). F. B. Schneider, Ed. PODC '87. ACM, New York, N.Y., 1-12, which is fully incorporated herein by reference.

Whereas push is used to expedite update propagation, pull is to ensure no update is missing by a device, which is required by eventual consistency. Supporting both push and pull requires novel design on concurrency control algorithms, which is described below. More sophisticated epidemic algorithms such as gossiping can be used to further optimize update propagation.

In either push or pull, a device may propagate updates originated from other devices. Therefore, the system does not assume the source of an update.

### Update Propagation: Concurrency Control

According to one embodiment, classic version vectors are used to track causal relations of updates. Version vectors are a data structure used in optimistic replication systems. The form {A1, B2, C5} denotes a version vector, where A, B and C are device ids and 1, 2, and 5 are their respective version numbers. A more detailed description of version vectors is provided in Parker et al., “Detection of Mutual Inconsistency in Distributed Systems,” IEEE Transactions on Software Engineering, Vol. SE-9, No. 3, May 1983, pp. 240-247, which is fully incorporated herein by reference.

For example, on device A, the current version vector of a component is {A1, B2, C5}. When A updates the component, it needs to increment the version number corresponding to its own device id by one. Therefore, a new version vector of the component will become {A2, B2, C5} after the update. Device A then propagates the update along with the new version to other devices.

### Version Tables

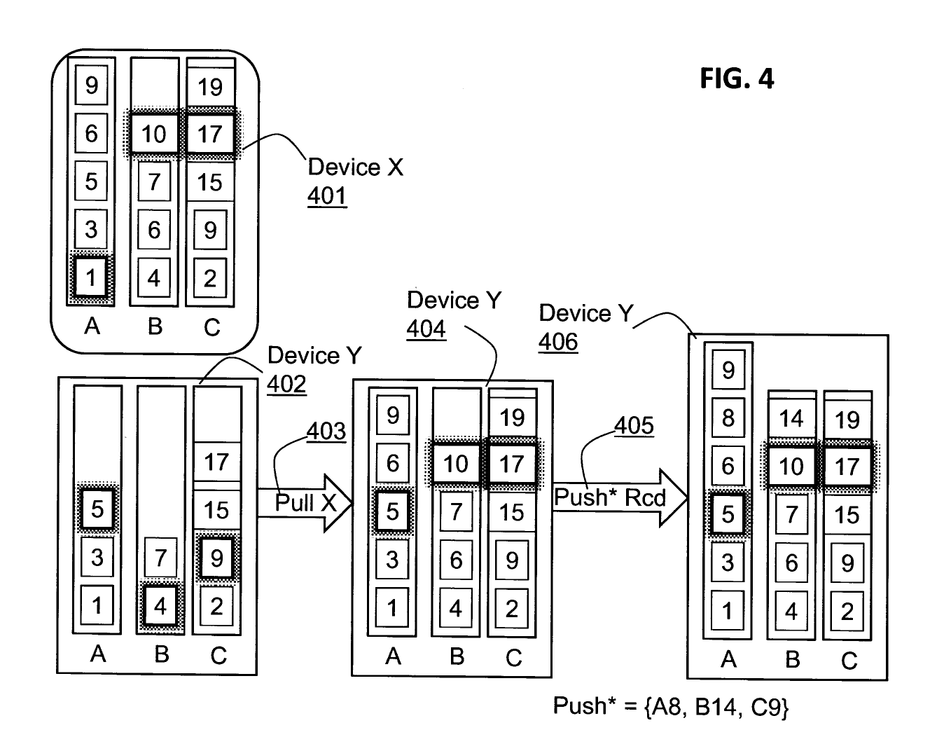

FIG. 4 illustrates an exemplary version table for use with the present system, according to one embodiment. Two devices, device X 401 and device Y 402 have version tables. To maintain version vectors, each device remembers the version it has received so far in a database-table-like data structure, a version table. Each row of the table consists of three tuples: a component id, a device id, and a version number. The table is indexed by device ids and sorted by version numbers. Each rectangle in FIG. 4 represents a row in the table with device ids and component ids omitted. Rectangles with the same device id are placed in one sorted column denoted by the device id.

There is a version vector associated with each device, a knowledge vector. Knowledge vectors are used to determine “stableness” of version numbers. The knowledge vector is initially empty. In FIG. 4, device X's 401 knowledge vector is {A1, B10, C17}.

Pull-based propagation maintains version tables as follows: when a device Y 402 pulls 403 from device X 401, device Y 402 sends its knowledge vector ({A5, B4, C9} in FIG. 4) to a device X 401. Device X 401 then replies with all the version numbers that are “greater than” device X's 401 knowledge vector to device Y 402. The device ids and component ids associated with these version numbers are also transmitted. In the example illustrated in FIG. 4, the numbers being replied are A6, A9, B10, C15, C17, and C19. Upon receiving these numbers, device Y 404 stacks them into its own version table 404.

In addition, device X 401 also sends its knowledge vector to device Y 404. Y then “merges” this vector with its own knowledge vector: Version numbers in the new vector are the pair-wise maximum between the two input vectors. In the example, device Y's 404 new knowledge vector becomes {A5, B10, C17}.

Whenever a device receives a push-based propagation, it inserts the received version numbers into its table, but makes no change on the knowledge vector.

### Stability of Version Numbers

Devices may miss pushed messages because of unreliable networks or simply because the device is offline when the push happens. Therefore, pulls are used to guarantee that a device retrieves all missing updates. A naïve approach of pulling is to fetch all versions the target device has. However, it is inefficient if the amount of version numbers is huge. Therefore, only versions unknown to the pulling device are transferred with the help of knowledge vectors.

Version numbers in device Y's 404 knowledge vector are said to be stable to device Y 404. It can be shown that using the process described in the last section, if a version number n from device X 401 is stable to device Y 404, then any version numbers from device X 401 that are smaller than n are already known (received) to device Y 404.

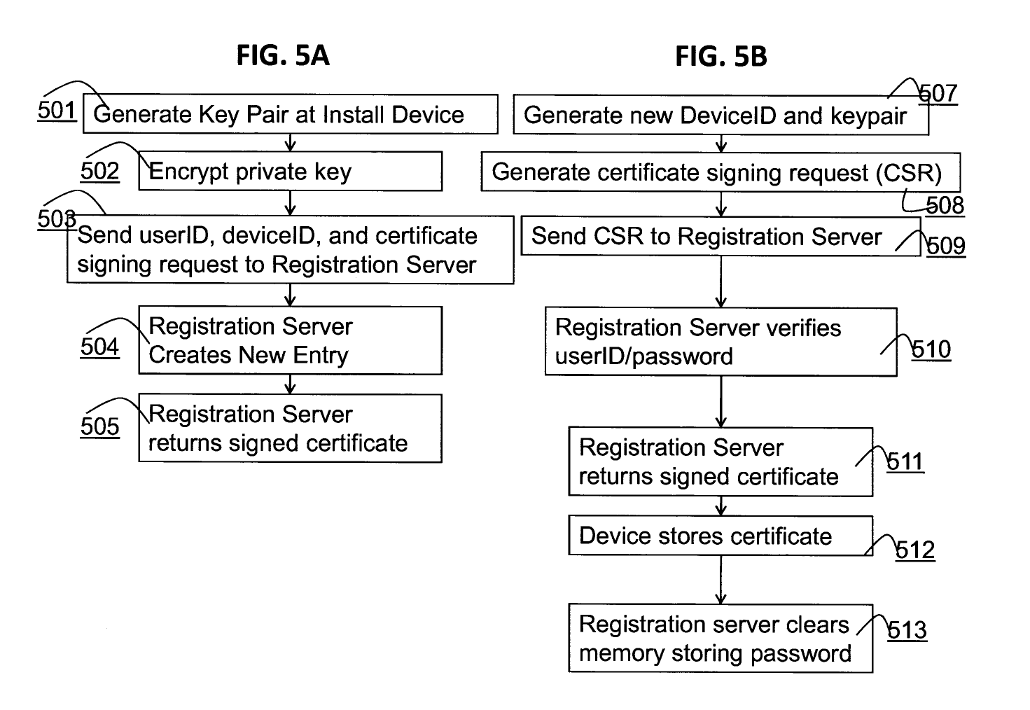

Whenever a device receives a push-based propagation, it inserts the received version numbers into its table, but makes no change on the knowledge vector. FIG. 5 includes an example of a push 405 operation.

### Conflict Handling

A conflict occurs if two or more devices update the replicas of the same component at the same time. The system detects conflicts by comparing the version vector of a component received from another device with the local version vector. A syntactic conflict is detected if neither vector dominates the other. The present device adopts different methods to solve conflicts for metadata and content components. To solve conflicts for user-defined component types, an application developer writes conflict resolvers and registers them with a component plug-in framework.

### Conflict Handling: Metadata Conflicts

When a metadata conflict is detected between two versions, the present device solves the conflict automatically by discarding an arbitrary version of the two. Because more than one device may independently detect and solve the conflict at the same time, it is important that the resolution process outputs the same result, regardless of when and at which device the process is executed, and from where the conflicting versions are received. To achieve this, the present system selects one of the two versions using the following method.

First, as part of metadata, a timestamp is associated with each object and is replicated with the object. When a device updates any part of metadata, it also updates the timestamp with local wall clock time. Second, the conflict resolution process compares the timestamps from the two conflicting versions, and selects the one with a smaller timestamp. Ties are broken by comparing the largest device ids from the two version vectors. A device id is said to be larger than the other if the former's lexical value is larger than the latter's.

### Conflict Handling: Content Conflicts

According to one embodiment, when a content conflict is detected, both conflicting versions are kept as branches. The local version is kept as the master branch and the remote version is kept as a conflict branch. When a new update is received on a file that already has branches, the update's version vector is compared against the vectors of all the branches. If the update's vector dominates any branch, the update is then applied to that branch. Otherwise, a new conflict branch is generated.

File access made through the local file system is by default directed to the master branch. Therefore, users can continue working on their own branches if conflicts occur. Meanwhile, the present device exposes APIs that allow users to read-only access the content of conflict branches.

Users may examine conflict branches and then either merge the content into the master branch or simply discard the branch. In either case, they may issue an API call to delete a specified conflict branch. Upon receiving the call, the present device deletes the content of the branch, and “merges” the version vector of the conflict branch into the master branch, so that the new vector are the pair-wise maximum between the two vectors across all vector entries. The present device also increments the version number corresponding to the device in the new version vector.

### Conflict Handling: Content Merger Plug-ins

When merging the content of a conflict branch into the master branch, the user may choose to manually do so, or let the present device automate the process. Because how the content may be merged depends on the structure and semantics of the content which is application-specific, the present device relies on content merger plug-ins to merge files in application-specific ways. Applications register with content merger plug-ins. The plug-in may choose to automatically merge conflicting contents, or prompt and wait for user interactions.

Each plug-in is associated with a file path pattern specifying the set of files the plug-in is able to handle. For example, Microsoft Word may register a plug-in with file path pattern “*.doc” to handle all files ended with “.doc”. A calendar program may register a plug-in with pattern “*/calendar/*.dat” so it only handles files satisfying this pattern but not all files ending with “.dat”.

### Conflict Handling: Name Conflicts

When two or more devices update different objects at the same time, no version conflicts would occur. However, these updates may cause name conflicts. For example, a name conflict occurs if one device creates a folder and in the meantime another device renames an existing file to the same name. The present device handles name conflicts as follows.

The present device arbitrarily discards one of the two conflicting updates. Two or more devices may attempt to solve the conflict independently at the same time. Therefore, a similar method is used. The present system compares the timestamps of the conflicting metadata and discards the one with a smaller timestamp. Ties are broken by comparing the object ids of the two objects.

### Pins

According to one embodiment, users assign user pins to arbitrary files and folders. As previously described above, subsets of the data to be kept in a device are determined based on object usage pattern. A device may not have the entire dataset of a library if its space is constrained. When a user accesses objects that are not stored locally, object data is streamed from other devices. However, in some circumstances, the user may want some objects always accessible locally. Pinned files and all the files under pinned folders are never removed from the device, unless the amount of pinned files exceeds the capacity of the device. In this case, the user pin flags are disregarded and pinned files get evicted. The user is notified of the capacity issue.

### Pins: Auto Pins

According to one embodiment, a user can specify the least number of copies of a file which should be available globally, for availability or other purposes. Because files may be evicted from any device, at least one copy of any given file must be guaranteed to exist at any time. This per-file number is a replication factor, “r”. It is one by default.

According to one embodiment, when a file is created, the file is replicated to r devices including the local device, and an auto pin is assigned to the file on each of the r devices. The file creation procedure blocks until all these operations complete. Files that are auto pinned are not allowed to be evicted under any circumstances, whether the files are user pinned or not. Thus, the system guarantees that there are at least r replicas.

### Pins: Auto Pin Handoff

If the amount of auto pinned files is about to reach the capacity of the device, the device may hand off auto pinned files to other devices. To hand off a file, the initiating device replicates the file to the receiving device, sets the auto pin flag on the receiving device, and then removes the auto pin from the initiating device. Once the auto pin is removed, the initiating device is free to evict the file. Handoff needs to be negotiated, because the receiving device may not have enough space, either. When a handoff request is rejected, the initiating device needs to search for other devices willing to accept the request. Otherwise, it will not be able to reclaim space.

### Pins: Auto Pin Rebalancing

According to one embodiment, handoff happens not only when a device's storage is full. Each device continuously hands off auto pins to other devices to keep the amount of auto pinned files under a certain threshold t1 relative to the capacity of the device, so that the entire system can be balanced in terms of replica distribution, data availability, and device load. In order to avoid thrashing, a device may refuse to accept handoff requests for the purpose of auto pin rebalancing, if the amount of auto pinned files on that device has exceeded a threshold t2 relative to device capacity. Threshold t2 is always greater than t1.

### Installation

FIG. 5A illustrates an exemplary initial installation process for use with the present system, according to one embodiment. During initial installation, a new user public/private key pair is generated by the install target (i.e. computer, device) 501. The private key is encrypted using the user's provided password (examples of encryption algorithms include PBKDF2 and AES) 502. The user ID, as well as a device ID (generated by the device) and a Certificate Signing Request (CSR) (derived from the user's public key and device id) are sent to the registration server 503. The registration server in turn creates a new entry for the user 504. The server also returns a certificate signed by the CA to the user device 505. The server returns an error ode if either user or device id is already registered.

According to one embodiment, the above information is also permanently stored on the install target. The user and device id is saved in an ASCII configuration file; the certificate and the encrypted private key are saved in separate, BASE64 encoded files. The password is saved in the configuration file, encrypted with a symmetric key. The user may delete the password from the configuration file, which forces the system to prompt for a password upon every launch.

FIG. 5B illustrates an exemplary subsequent installation process for use with the present system, according to one embodiment. On subsequent installations, a new device id and public/private key pair is generated 507. A new certificate signing request (CSR) is generated derived from the user's new public key and device id 508. The certificate signing request is sent to the server 509. The server verifies the user id and password 510, and upon successful verification, the server will return a certificate signed by the CA to the user device 511, which in turn writes them to local memory 512. Upon verification, the registration server clears the memory region holding the password 513.

### User Login

According to one embodiment, users are prompted for a password upon login. The password is used to decrypt the private key stored on the local drive, and then the key is tested against the locally stored public key using the challenge-based method.

According to one embodiment, the challenge-based method takes a public key and a private key as the input and outputs a Boolean value indicating whether the private key matches the public key. The method generates a randomly generated payload using a secure random number generator and encrypts the bytes with the public key (one possible encryption algorithm is RSA/ECB/PKCS1Padding). The encrypted data is decrypted with the private key and is then compared against the original payload for equality. The overall method returns true if all the steps succeed and returns false otherwise.

According to one embodiment, no communication is required between the client device and the registration server for user login. This is to facilitate offline operations.

### Remote User Authentication

A user is authenticated to the local system upon login. However, in order to interact with remote devices, distributed authentication is required. Unlike server-based solutions such as Kerberos, the present system performs peer-to-peer authentication for maximum availability. To automate the authentication process, the user's decrypted private key and public Certificate is stored in memory after the user logs in, and this key and Certificate pair is used whenever a peer authentication is requested using standard PKI DTLS/TLS procedures involving certificate exchange.

If a user failed to authenticate to a library, because the certificate is invalid, she is automatically treated as an anonymous user, and granted access to the operations available to anonymous users.

### Library Authentication

While users must be authenticated for library access, devices also need to prove to the user the authenticity of the libraries they are serving. Therefore, a certificate is associated with each library.

The user may create a new library on any device she owns. The device is in fact the first contributing device of the new library. During library creation, the device generates a public/private key pair for the library, and sends a Certificate Signing Request to the Certificate Authority. Upon receiving the certificate from the CA, the creating device saves both the certificate and the private key in plaintext into the administrative directory of the library, protected with proper access permissions, so that devices that contribute to the library can use these materials to proof the library's authenticity to remote devices.

When a user accesses the library from a remote device, a standard bi-directional certificate exchange authentication scheme is used to authenticate both the user and the library at the same time, as well as to establish a secure channel between the two parties. The handshake terminates immediately if the library cannot be authenticated. Because libraries are operated independently, there might be multiple secure channels between two devices at the same time, one for each library.

### Distributed Access Control List (ACL)

According to one embodiment, the present system imposes discretionary access control (DAC). Each object (or file) is assigned an access control list (ACL) specifying which users may perform what operations on the object. ACLs are part of object metadata, synchronized across devices the same way as other object metadata does. ACL follows DAC semantics found in Microsoft Windows. ACLs are the building block for higher-level security services like membership management.

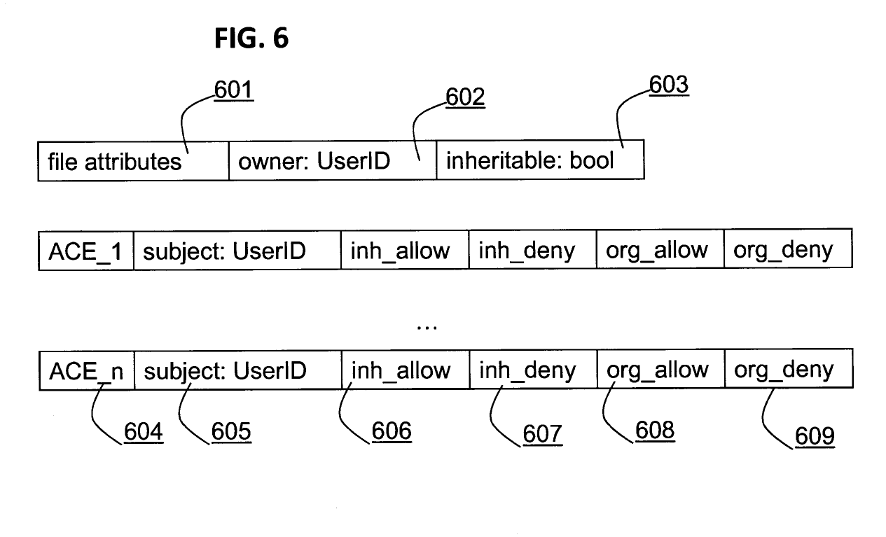

FIG. 6 illustrates an exemplary access control list for user with the present system, according to one embodiment. An owner field 601 specifies the owner 602 of the object 601, with initial value being the user id of the device where the object is created. The inheritable field 603 specifies whether to inherit Access Control Entries (ACEs) from the parent object, with initial value true. An ACL may also contain zero or more ACEs, each specifying access rights for a particular subject. The initial ACL is empty.

An ACE 604 has several fields. The org_allow field 608 specifies the rights allowed to the subject and field org_deny 609 specifies the rights denied to the subject. Fields inh_allow 606 and inh_deny 607 define allowed and denied rights that are inherited from the parent, respectively. The value of these fields is a combination of zero or more rights. A right is a set of operations. Supported rights and their corresponding operations are listed in Table 1 below.

Permission checking is enforced for both local and remote operations. The login user is regarded as the subject for local operations. When a remote operation is attempted, the remote device's owner is the subject. For example, when user A's device D sends an object O to user B's device E, D checks if B can READ O, and E checks if A can WRITE O. The transaction proceeds only if both conditions are satisfied.

TABLE 1
Rights and Operations

| Rights | Operations |
|---|---|
| READ | Read metadata including ACL |
| | For files: read content |
| | For dirs: list the children that the |
| | subject may READ |
| WRITE | Write metadata excluding ACL |
| | Rename the object (name and parents |
| | are part of metadata) |
| | Move the object if the subject may WRITE |
| | both source and destination directories |
| | Delete the object if the subject |
| | may WRITE the parent |
| | For files: write content |
| | For dirs: remove or add children |
| WRITE_ACL | Update any field in ACL |

### Solving ACL Update Conflicts

When two devices update an ACL concurrently (i.e. the two updates have no causal relationship), a metadata conflict occurs. When a device detects a metadata conflict, the present system solves it automatically by selecting an arbitrary version from the two and discarding the other one. Because more than one device may detect and solve the conflict independently at the same time, it is important that the resolution process outputs the same result, regardless of when and at which device the process is executed, and from where the conflicting versions are received. To achieve this, the present system selects one of the two versions using a deterministic method as described herein.

### Administrative Directory

Similar to/etc on UNIX systems, there is a special directory in each library. All administrative tasks for the library such as user and device management are done by manipulating objects and their ACLs within the directory. Although users may do so manually, the present user interface helps accomplish common tasks with a few mouse clicks. For example, the interface provides three user types. When a user is given a certain type, the interface applies predefined permissions to various objects, so that the user is able to perform tasks that are privileged to that type. Example user types and their privileges are:
Managers. Add and remove Managers and Contributors, plus Contributor's privileges.
Contributors. Contribute owned devices to the library.
Others. No privileges except to access objects the user is permitted to.

According to one embodiment, users with appropriate permissions may override user types and privileges by manually changing ACLs. Table 2 lists objects as well as their predefined permissions for Managers and Contributors (Others have no permissions at all).

TABLE 2
Objects & Permissions

| | | org_allow | org_allow |
|---|---|---|---|
| Path | Inher- | for | for Con- |
| Comments | itable | Managers¹ | tributors¹ |
| / | T | RWA | RW |

The root directory

| | | | |
|---|---|---|---|
| /.aerofs | F | RWA | R |

The administrative root

| | | | |
|---|---|---|---|
| /.aerofs/users | T | Ø | Ø |

The directory for per-user data

| | | | |
|---|---|---|---|
| /.aerofs/users/u | T | Ø | Ø |

The directory for user data where u is a user id.

| | | | |
|---|---|---|---|
| /.aerofs/users/u/devices | T | Ø | W or Ø² |

The directory for per-device data

| | | | |
|---|---|---|---|
| /.aerofs/users/u/devices/d | T | Ø | Ø |

The directory containing information of a contributing device, where d is
a device id. From any device's point of view, a device contributes to the
library if and only if there is such a directory corresponding to this device.

| | | | |
|---|---|---|---|
| /.aerofs/users/u/devices/d/device.conf | T | Ø | Ø |

Device configuration file specifying device aliases etc.

| | | | |
|---|---|---|---|
| /.aerofs/users/u/devices/d/var | T | Ø | Ø |

The device writes files into this directory to notify its runtime
statistics to other devices.
¹R = READ, W = WRITE, A = WRITE_ACL. The org_deny field is Ø. Inh_allow and inh_deny fields are computed.
²W if the Contributor's user = <user> and Ø otherwise.

### EXAMPLE

### Add A Contributing Device to a Library

A better understanding of how components work together is achieved through the following example. The example involves adding a Contributor C to an existing library L. C then contributes her device D to L.

An existing Manager M adds user C from M's own device E. Device E performs the following steps:

Create directories L/.aerofs/users, /.aerofs/users/u_{c}, and /.aerofs/users/u_{c}/devices, where u_{c} is C's user id;

Add ACE: object=L/, subject=C, org_allow={WRITE, READ}, org_deny=ø;

Add ACE: object=L/.aerofs, subject=C, org_allow={READ}, org_deny=ø;

Add ACE: object=L/.aerofs/users/u_{c}devices, subject=C, org_allow={WRITE}, org_deny=ø.

The updates are then propagated to other devices. Because M as a Manager has full access to objects under /.aerofs, he is allowed to update them, and E is allowed to send these updates to other devices.

Subsequently, when user C instructs her device D to contribute to L, D first finds a device F that contributes to L. Assuming F has applied all the updates made by E, F is able to verify D's authenticity by using C's certificate and establish a security channel with D.

Device D then retrieves from F the directory L/.aerofs/users/u_{c}/devices, and creates a new directory U_{D} as well as a new file u_{D}/device.conf under this directory, where u_{D} is the device id of D (the parent directory is replicated locally before new objects can be created within it). The new directory is pushed to device F, so that F can recognize D as a contributor of library L and start synchronizing with it.

As directory L/.aerofs/users/u_{D}/devices/u_{D} gets propagated to other devices, they start recognizing D. Eventually, all contributing devices of L will recognize D, which concludes the entire joining process.

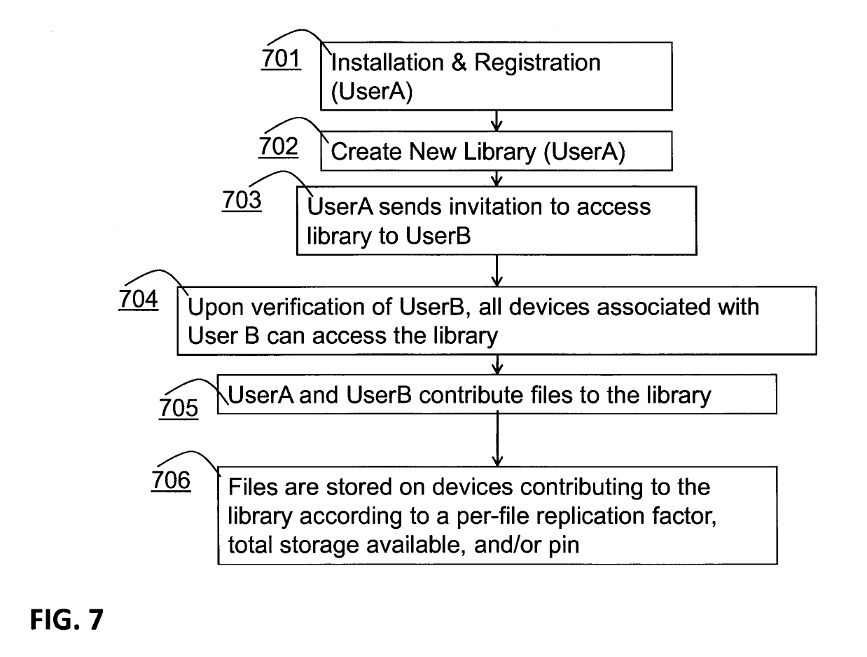

FIG. 7 illustrates an exemplary library management process for use with the present system, according to one embodiment. A user (UserA) installs library management software on a device and registers the device and the user with a registration server 701. UserA can then create a new library 702 and invite others to access the library. In this example, UserA invites UserB to access the library 703. UserA's device verifies UserB and grants access to the library 704. In this case, all devices associated with UserB are granted access to the library. As UserA and UserB contribute files to the library 705, they are able to assign a replication factor to each file and/or pin each file to a particular device. As such, files are stored on devices having access to the library according to a per-file replication factor, the total storage available, and any pinning that has been designated 706. Examples and detailed descriptions of replication factor, pinning, total storage, contributing to a library, creation of library, verification, devices, and registration server have been described in the foregoing sections of this document.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

A system and method for cloud file management are disclosed. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

We claim:

1. A non-transitory computer-readable medium having stored thereon a plurality of instructions, the instructions when executed by a processor causing the processor to perform:
registering a first user and a first device with a server over a network;
creating a library for object storage;
transmitting an invitation to access the library to a second user, the second user having a second device;
verifying and granting the second user access to the library, wherein granting the second user access to the library comprises granting the second device access to the library; and
storing an object having a replication factor and two or more components on one or more of the first device and the second device according to the replication factor and total storage available on the first device and the second device.

2. The computer-readable medium of claim 1, wherein one of the first user or the second user designates that the object be stored on one of the first device or the second device.

3. The computer-readable medium of claim 1, wherein the first device and second device communicate directly without having knowledge of actual transport implementations.

4. The computer-readable medium of claim 1, wherein version vectors are used to track updates to components.

5. The computer-readable medium of claim 1, wherein the plurality of instructions when executed by the processor cause the processor to further perform resolving a conflict, wherein a conflict occurs when the first device and the second device update a first replica and a second replica of a component at the same time.

6. The computer-readable medium of claim 5, wherein the conflict is one of a metadata conflict, a content conflict, or a name conflict.

7. The computer-readable medium of claim 1, wherein the object has an access control list, the access control list specifying operations that each of the first and second users can perform on the object.

8. The computer-readable medium of claim 7, wherein the first device and the second device update a first replica and a second replica of the access control list concurrently and, as a result, one of the first replica or second replica are discarded.

9. The computer-readable medium of claim 1, wherein the library comprises an administrative directory, the administrative directory comprising user types and privileges, the privileges defining permission to perform a task on the object.

10. A computer-implemented method, comprising:
registering a first user and a first device with a server over a network;
creating a library for object storage;
transmitting an invitation to access the library to a second user, the second user having a second device;
verifying and granting the second user access to the library, wherein granting the second user access to the library comprises granting the second device access to the library; and
storing an object having a replication factor and two or more components on one or more of the first device and the second device according to the replication factor and total storage available on the first device and the second device.

11. The computer-implemented method of claim 10, wherein one of the first user or the second user designates that the object be stored on one of the first device or the second device.

12. The computer-implemented method of claim 10, wherein the first device and second device communicate directly without having knowledge of actual transport implementations.

13. The computer-implemented method of claim 10, wherein version vectors are used to track updates to components.

14. The computer-implemented method of claim 10, further comprising resolving a conflict, wherein a conflict occurs when the first device and the second device update a first replica and a second replica of a component at the same time.

15. The computer-implemented method of claim 14, wherein the conflict is one of a metadata conflict, a content conflict, or a name conflict.

16. The computer-implemented method of claim 10, wherein the object has an access control list, the access control list specifying operations that each of the first and second users can perform on the object.

17. The computer-implemented method of claim 16, wherein the first device and the second device update a first replica and a second replica of the access control list concurrently and, as a result, one of the first replica or second replica are discarded.

18. The computer-implemented method of claim 10, wherein the library comprises an administrative directory, the administrative directory comprising user types and privileges, the privileges defining permission to perform a task on the object.
